(19) United States
(12) Patent Application Publication
(10) Pub. No.: US 2025/0290601 A1
(43) Pub. Date: Sep. 18, 2025

(54) MULTI-LAYERED VESSEL WALL

(71) Applicant: BENNAMANN SERVICES LTD, Newquay, Cornwall (GB)

(72) Inventor: Luke James Mann, Newquay, Cornwall (GB)

(73) Assignee: BENNAMANN SERVICES LTD, Newquay, Cornwall (GB)

(21) Appl. No.: 18/860,326

(22) PCT Filed: May 10, 2023
(86) PCT No.: PCT/IB2023/054843

§ 371 Date: Oct. 25, 2024

Related U.S. Application Data
(60) Provisional application No. 63/340,739, filed on May 11, 2022.

(51) Int. Cl. F17C 1/14

(52) U.S. Cl. CPC F17C 1/14; F17C 2201/0147; F17C 2203/012; F17C 2203/0391; F17C 2203/0619; F17C 2203/0629; F17C 2203/0643; F17C 2203/0646; F17C 2209/221; F17C 2209/232; F17C 2221/033; F17C 2265/066; F17C 2270/0178

(57) ABSTRACT

A multi-layered vessel may include a first vessel layer and a retaining vessel layer. The retaining vessel layer may be configured to strengthen the first vessel layer, and the retaining vessel layer may be secured to outer walls and/or inner walls of the first vessel layer. The first vessel layer alone (or with the retaining vessel layer and/or one or more additional retaining vessel layers) may form a sealed vessel.

### CROSS-REFERENCE TO RELATED APPLICATION

The present application claims the benefit of priority to U.S. Provisional Application Ser. No. 63/340,739, filed on May 11, 2022, which is incorporated herein by reference in its entirety.

### BACKGROUND

### Field of Invention

The present invention relates generally to vessels and, in particular, pressure vessels in storage tanks for the cryogenic storage of liquid methane, as well as its delivery as fuel, for instance, to power generation systems such as engines.

### Discussion of the Background

Pressure vessels (e.g., pressure vessels that have a non-circular shape, such as a rectangular shapes) having a single layer are not both easy to manufacture in large quantities and strong. The thickness of the material of the vessel is a large factor in vessels being at least one of weak and difficult to manufacture in large quantities. The preferred manufacturing process for pressure vessels is pressing or stamping. Pressing is difficult when the thickness of the material (e.g., steel) of the vessel is 6 mm or greater. Drawbacks associated with pressed production of steel having a thickness of 6 mm or greater include (i) high forces being needed during pressing, which result in an increased press cost, an increased tooling cost, and/or work hardening of material, (ii) limited deep drawing, (iii) an increased bend radius, (iv) increased material thinning, (v) a limited number of bent edges, and/or (vi) limited complexity. However, if the material thickness is decreased to avoid the above-mentioned pressing difficulties, the strength of the pressed vessel is decreased. To increase strength, internal structure, outer support structure, or complexity may be added, but these reduce capacity and manufacturability.

FIG. 1 illustrates the strength of a single layer vessel 100 made of pressed steel having a thickness of 6 mm. FIG. 2 illustrates the strength of a single layer vessel 200 made of pressed steel having a thickness of 4 mm. FIG. 3 illustrates the strength of a single layer vessel 100 made of pressed steel having a thickness of 6 mm. Vessels 100 and 200 have a flat surface, and vessels 300, 400, and 500 have a trench 302. The strengths of the single layer vessels 100, 200, 300, 400, and 500 are shown in grayscale, with the weakest areas shown in black and the strongest areas shown in white. As shown in FIGS. 1-5, the strengths of the single layer vessels 100, 200, 300, 400, and 500 decrease as the material thickness decreases. As shown in FIGS. 3-5, the trench 302 increases the strength of the vessels 300, 400, and 500 (relative to a vessel having the same material thickness but not trench). As shown in FIGS. 4 and 5, even with the trench 302, the single layer vessels 400 and 500 made of the steel thinner than 6 mm, which would makes the vessels 400 and 500 easier to manufacture by pressing, have weak areas.

### SUMMARY

Aspects of the invention may overcome one or more of the problems associated with conventional vessels by providing a vessel (e.g., a pressure vessel) having multi-layered walls. In some aspects, one layer of the vessel may be provided by a sealed vessel, and a second layer of the vessel may be provided by a retaining vessel configured to strengthen the walls of the sealed vessel. In some aspects, the sealed vessel may be a thin-walled vessel (e.g., so that it can be pressed) and completed sealed. In some aspects, the retaining vessel may be shaped to be around or inside the sealed vessel. In some aspects, the retaining vessel may be cut down (e.g., to provide openings in the retaining vessel) to as little material as needed to provide a required strength. In some aspects, the sealed vessel may ensure leak tightness, and the retaining vessel may add strength where needed. In some aspects, the sealed vessel and the retaining vessel may be secured together (e.g., using welding, crimping, or forming). In some aspects, the vessel having multi-layered walls may be both easy to manufacture in large quantities and strong.

Aspects of the invention may provide the strength of a thicker layer by dividing the thick into multiple, thinner layers that are easier to manufacture. For example, a multi-layered vessel may provide the strength of a vessel having 12 mm thick steel through multiple layers (e.g., two 6 mm layers, three 4 mm layers, four 3 mm layers, etc.). For example, a multi-layered vessel may provide the strength of a vessel having 6 mm thick steel through multiple layers (e.g., two 3 mm layers, three 2 mm layers, or a 4 mm layer and a 2 mm layer, etc.).

One aspect of the invention may provide a multi-layered vessel including a first vessel layer and a retaining vessel layer. The retaining vessel may be configured to strengthen the first vessel layer. The retaining vessel layer may be secured to outer walls and/or inner walls of the first vessel layer.

In some aspects, the first vessel layer may form a sealed vessel. In some alternative aspects, the first vessel layer and the retaining vessel layer may overlap and form a sealed vessel. In some alternative aspects, the multi-layered vessel may further include one or more additional retaining vessel layers, and the first vessel layer, the retaining vessel layer, and the one or more additional retaining vessel layers may overlap and form a sealed vessel.

In some aspects, the first vessel layer and/or the retaining vessel layer may include one or more strengthening structures. In some aspects, the one or more strengthening structures may include one or more strengthening beams. In some aspects, at least one of the one or more strengthening beams may include a trench in one of the first vessel layer and the retaining vessel layer that is closed by the other of the first vessel layer and the retaining vessel layer. In some aspects, the one or more strengthening structures may include curved or spherical depressions and/or raised areas, cross type recesses, and/or raised features.

In some aspects, the retaining vessel layer may include one or more openings.

In some aspects, the first vessel layer and the retaining vessel layer may each have a material thickness of 4 mm or less. In some aspects, at least one of the first vessel layer and the retaining vessel layer may have a material thickness of 3 mm or less.

In some aspects, the retaining vessel layer may be secured to the first vessel layer by welding, crimping, and/or forming. In some aspects, the retaining vessel layer may be secured to the first vessel layer by spot welding and/or plug welding.

In some aspects, the first vessel layer may include two or more first vessel layer components that are welded together to form the first vessel layer. In some aspects, the retaining vessel layer may include two or more retaining vessel layer components, and each retaining vessel layer component may be secured to a first vessel layer component of the two or more first vessel layer components. In some aspects, the two or more first vessel layer components and the two or more retaining vessel layer components may be pressed components. In some aspects, the two or more first vessel layer components and the two or more retaining vessel layer components may be pressed components having a material thicknesses of 3 mm. In some aspects, the two or more first vessel layer components may be pressed components having material thicknesses of 2 mm, and the two or more retaining vessel layer components may be pressed components having material thicknesses of 4 mm.

In some aspects, each of the two or more retaining vessel layer components may be secured to a first vessel layer component of the two or more first vessel layer components after the two or more first vessel layer components are sealed to form the first vessel layer. In some alternative aspects, one or more of the two or more retaining vessel layer components may be secured to a first vessel layer component of the two or more first vessel layer components before the two or more first vessel layer components are sealed to form the first vessel layer.

In some aspects, the retaining vessel layer may include two or more retaining vessel layer components, and each of the retaining vessel layer components may be secured to the first vessel layer.

Another aspect of the invention may provide a storage tank include the multi-layered vessel of any one of the aspects above, and the multi-layered vessel may be a first multi-layered vessel. The storage tank may further include a second vessel, and the first multi-layered vessel may be arranged within the second vessel or the second vessel may be arranged within the first multi-layered vessel.

In some aspects, the storage tank may be mounted in a vehicle and connected to an engine of the vehicle, and the storage tank may be configured to deliver methane to the engine. In some alternative aspects, the storage tank may be mounted in or on plant machinery and connected to a processor, and the storage tank may be configured as a buffer for fluid storage. In some aspects, the second vessel may be a second multi-layered vessel including a first vessel layer and a retaining vessel configured to strengthen the first vessel layer, and the retaining vessel layer of the second multi-layered vessel may be secured to outer walls and/or inner walls of the first vessel layer of the second multi-layered vessel. In some aspects, the storage tank may further include a vacuum gap between the first and second vessels.

Yet another aspect of the invention may provide a method. The method may include pressing two or more first vessel layer components. The method may include pressing two or more retaining vessel layer components. The method may include welding the two or more first vessel layer components together to form a first vessel. The method may include securing each of the two or more retaining vessel layer components to a first vessel layer component of the two or more first vessel layer components, and the secured two or more retaining vessel layer components may form a retaining vessel layer secured to inner and/or outer walls of the first vessel layer.

In some aspects, each of the two or more retaining vessel layer components may be secured to a first vessel layer component of the two or more first vessel layer components after the two or more first vessel layer components are sealed to form the first vessel layer. In some aspects, one or more of the two or more retaining vessel layer components may be secured to a first vessel layer component of the two or more first vessel layer components before the two or more first vessel layer components are sealed to form the first vessel.

Still another aspect of the invention may provide any combination of the aspects set forth above.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIGS. 1-5 illustrate the strengths of single layer vessels having different material thicknesses with or without trenches.

FIG. 6 illustrates a perspective view of a multi-layer vessel according to some aspects.

FIGS. 7A-7C illustrate perspective, front, and side views, respectively, of a first vessel layer of a multi-layer vessel according to some aspects.

FIGS. 8A-8E illustrate perspective, front, and side, perspective, and side views, respectively, of a retaining vessel layer of a multi-layer vessel according to some aspects.

FIGS. 9A and 9B illustrate perspective and side exploded views, respectively, of a multi-layer vessel according to some aspects.

FIGS. 10-12 illustrate the strengths of multi-layer vessels according to some aspects.

FIGS. 13A-13C illustrate perspective views of a multi-layer vessel according to some aspects.

FIGS. 14A and 14B illustrate perspective views of a first vessel layer of a multi-layer vessel according to some aspects.

FIGS. 15A and 15B illustrate perspective views of a retaining vessel layer of a multi-layer vessel according to some aspects.

FIG. 16 illustrates a cross-sectional view of a strengthening structure of a multi-layer vessel according to some aspects.

FIG. 17 illustrates a perspective exploded view of a multi-layer vessel according to some aspects.

FIGS. 18A-18E illustrate perspective and side views of a storage tank according to some aspects.

FIG. 19 illustrates a system for the storage and delivery of fuel according to some aspects.

FIG. 20 is a flow chart illustrating a process according to some aspects.

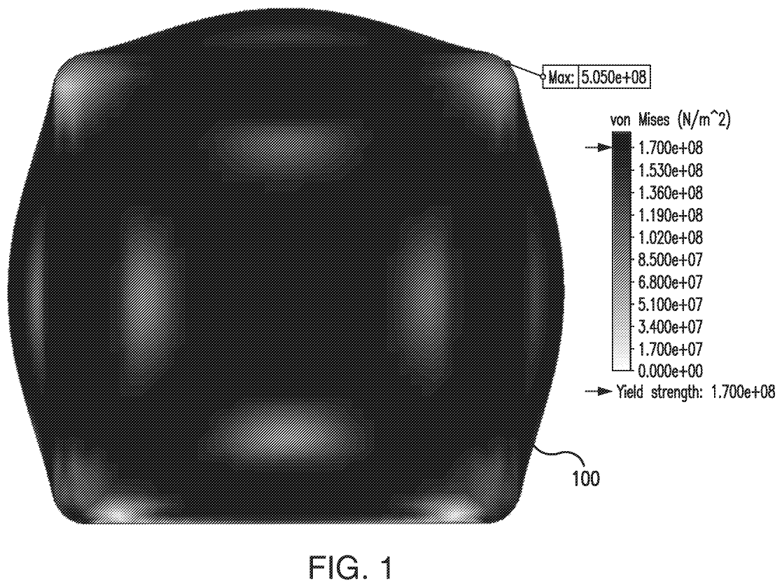

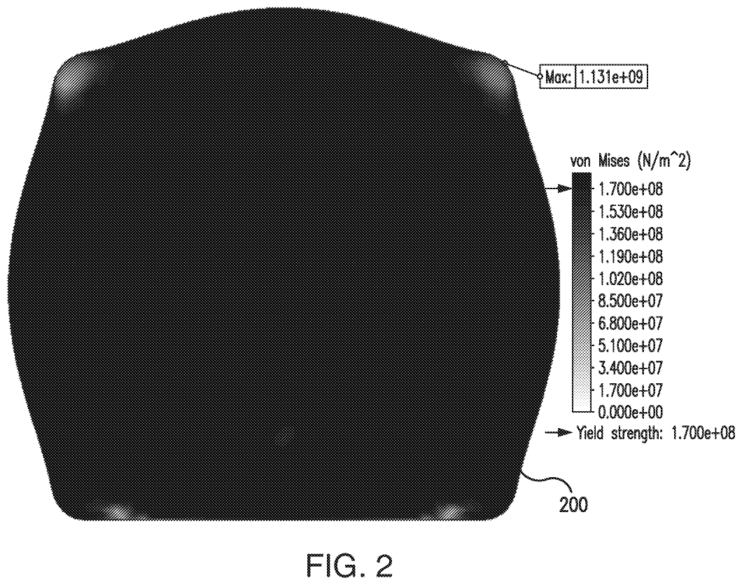

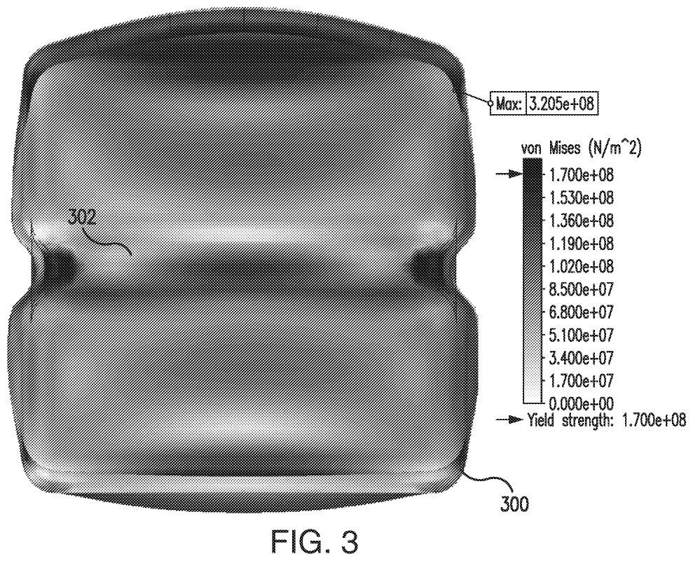

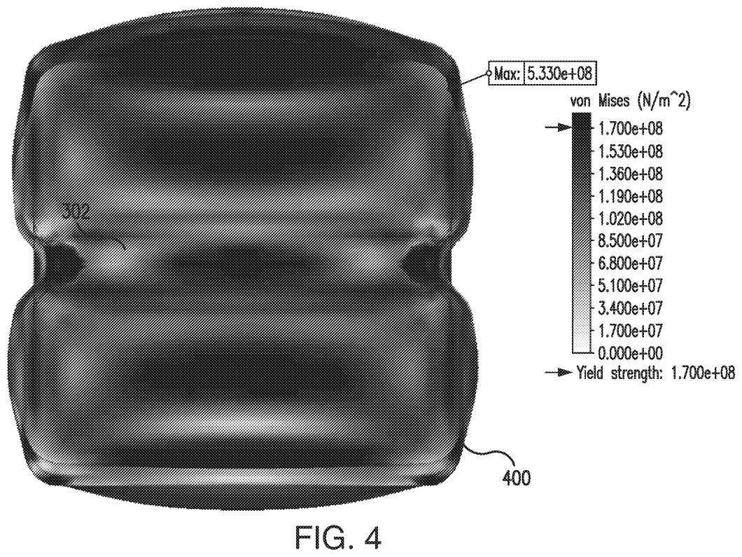

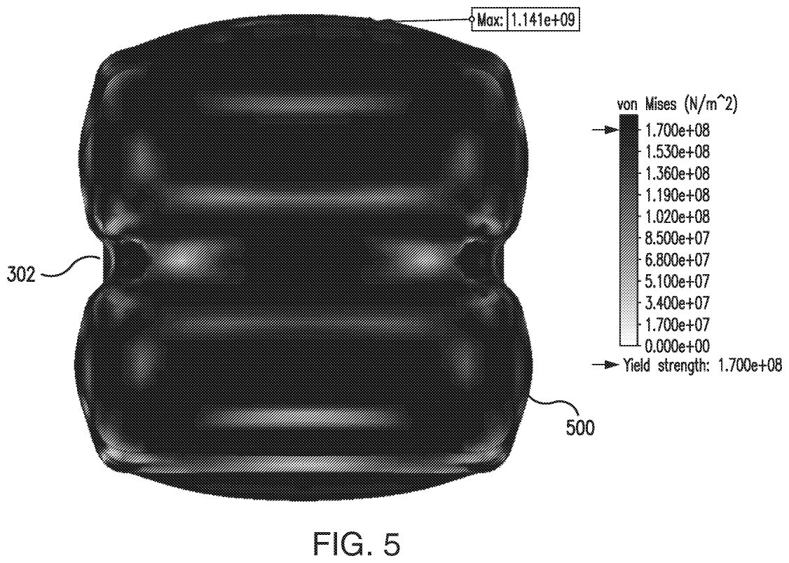

### DETAILED DESCRIPTION OF PREFERRED EMBODIMENTS

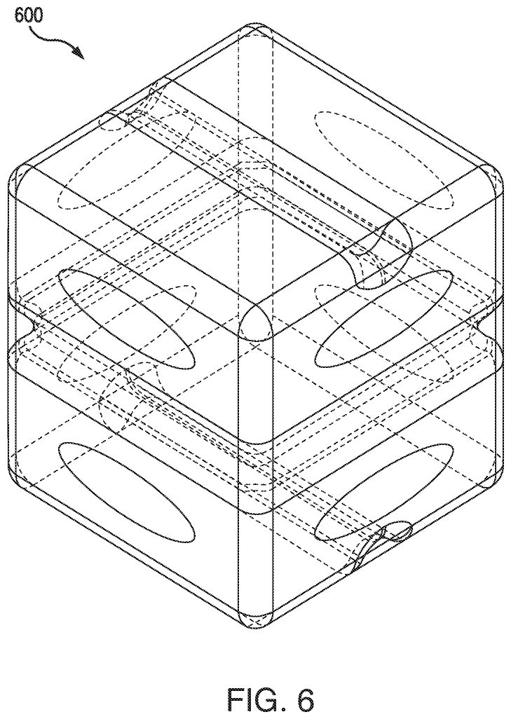

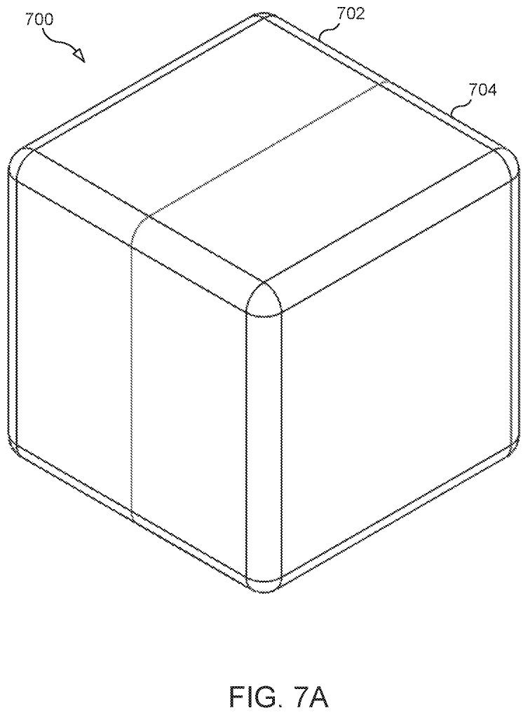

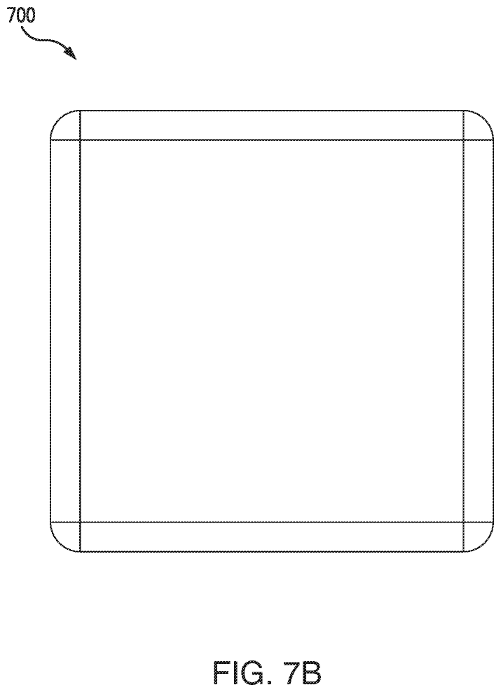

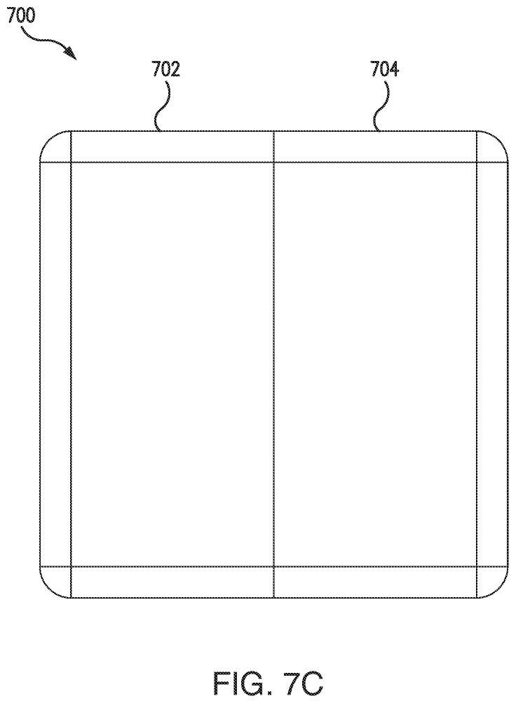

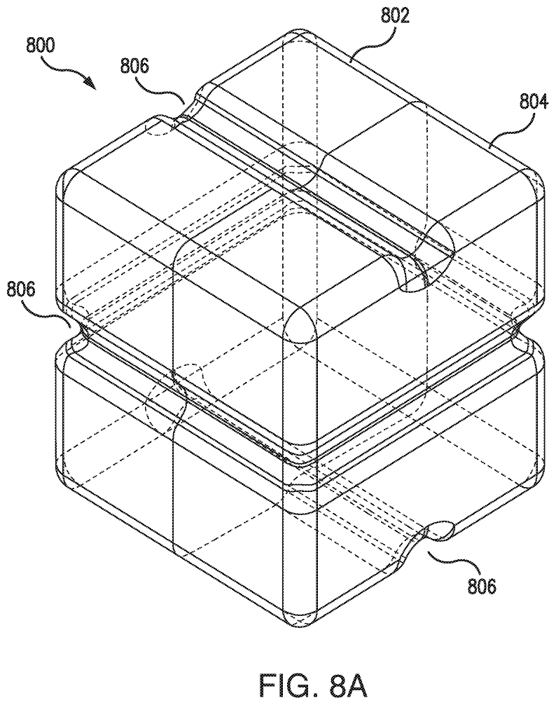

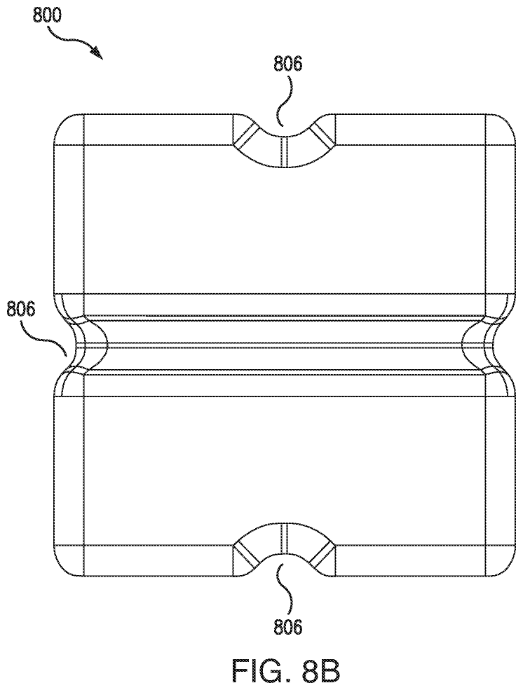

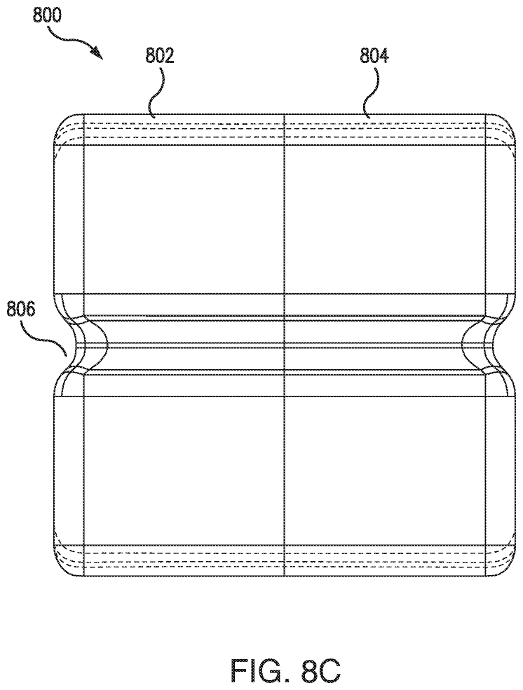

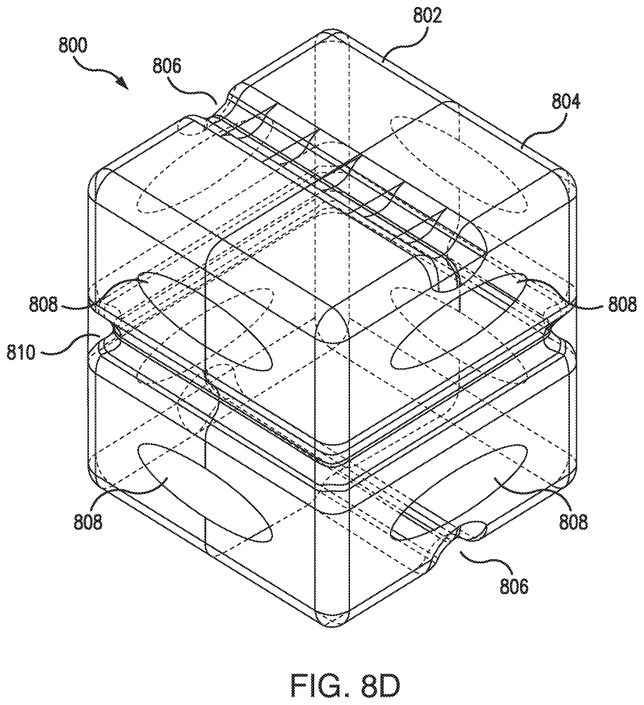

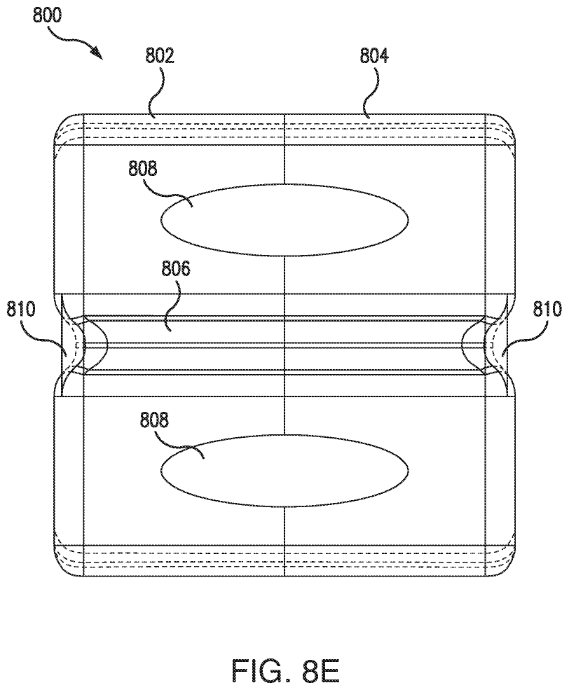

FIGS. 6-9B illustrate a multi-layered vessel 600 (e.g., a multi-layered pressure vessel) according to some aspects. In some aspects, the multi-layered vessel 600 includes a first vessel layer 700 and a retaining vessel layer 800. FIGS. 7A-7C illustrate the first vessel layer 700 of the multi-layered vessel 600 according to some aspects. FIGS. 8A-8E illustrate the retaining vessel layer 800 of the multi-layered vessel 600 according to some aspects. In some aspects, the first vessel layer 700 and the retaining vessel layer 800 may be made out of a material (e.g., steel).

In some aspects, the retaining vessel layer 800 may be configured to strengthen the first vessel layer 700. In some aspects, the retaining vessel layer 800 may be secured to inner walls of the first vessel layer 700. In some aspects, the retaining vessel layer 800 may be secured to the first vessel layer 700 by welding, crimping, and/or forming. In some aspects, the retaining vessel layer 800 may be secured to the first vessel layer 700 by spot welding and/or plug welding. In some alternative aspects, the retaining vessel layer 800 may be secured to the first vessel layer 700 by cold bonding (e.g., using a glue or adhesive). In some aspects, the retaining vessel layer 800 may be secured to the first vessel layer 700 by cold welding (e.g., including wire brushing and pressing the layers 700 and 800 together).

In some aspects, the first vessel layer 700 and the retaining vessel layer 800 may be made of the same material or different materials. For example, in some aspects, the first vessel layer 700 may be made of steel (e.g., stainless steel) or aluminum, and the retaining vessel layer 800 may be made of steel, aluminum, composite, or plastic.

In some aspects, as shown in FIGS. 7A-7C, the first vessel layer 700 may form a sealed vessel. In some alternative aspects, the first vessel layer 700 and the retaining vessel layer 800 may overlap and form a sealed vessel. In some further alternative aspects, the multi-layered vessel 600 may further include one or more additional retaining vessel layers, and the first vessel layer 700, the retaining vessel layer 800, and the one or more additional retaining vessel layers may overlap and form a sealed vessel.

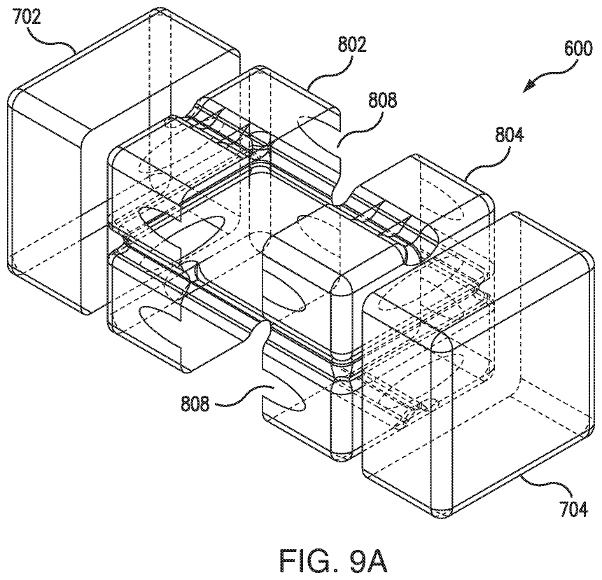

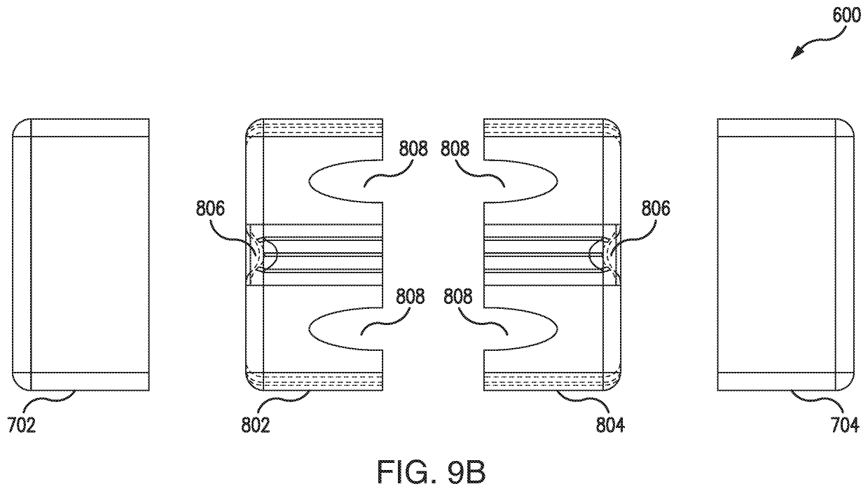

In some aspects, as shown in FIGS. 8A-9B, the retaining vessel layer 800 may include one or more strengthening structures 806. In some aspects, the first vessel layer 700 may additionally or alternatively include one or more strengthening structures 806. In some aspects, the one or more strengthening structures 806 may include one or more strengthening beams. In some aspects, at least one of the one or more strengthening beams 806 may include a trench in the retaining vessel layer 800 that is closed by the first vessel layer 700. In some aspects, the trench in the retaining vessel layer 800 that is closed by the first vessel layer 700 may have fluid in it. In some aspects, as shown in FIGS. 8A-9B, the trench of the one or more strengthening structures 806 may have a curved (e.g., U-shaped) cross-section. However, this is not required, and, in some alternative aspects, the trench may have a different shape (e.g., a V-shaped cross-section). In some aspects, the first vessel layer 700 and/or retaining vessel layer 800 may additionally or alternatively include one or more strengthening structures 806 having more complex geometries than trenches and beams. In some aspects, the one or more strengthening structures 806 having more complex geometries may, for example, have feature shapes that provide further strength across different surface directions and planes (e.g., curved or spherical depressions and/or raised areas, cross type recesses, and/or raised features). In some aspects, as shown in FIGS. 8D and 8E, the one or more strengthening structures 806 may include one or more supports 810 in a trench of the retaining vessel layer 800. In some aspects, the one or more supports 810 may be configured to abut the first vessel layer 700. In some aspects, the one or more supports 810 may be welded to the first vessel layer 700.

In some aspects, as shown in FIGS. 8D and 8E, the retaining vessel layer 800 may include one or more openings 808. In some aspects, the one or more openings 808 in the retaining vessel layer 800 may be located at the areas of the first vessel layer 700 that are strong and, thus, do not need to be strengthened by the retaining vessel layer 800. In some aspects, the one or more openings 808 may reduce the amount of material required for the retaining vessel layer 800. In some aspects, the one or more openings 808 in the retaining vessel layer 800 may reduce the weight of the retaining vessel layer 800 and, therefore, reduce the weight of the multi-layered vessel 600. However, the one or more openings 808 in the retaining vessel layer 800 are not required and, in some alternative aspects, as shown in FIGS. 8A-8C, the retaining vessel layer 800 may not include one or more openings 808.

In some aspects, as shown in FIGS. 7A, 7C, 9A, and 9B, the first vessel layer 700 may include two or more first vessel layer components 702 and 704 that are welded together to form the first vessel layer 700. In some aspects, as shown in FIGS. 8A and 8C-9B, the retaining vessel layer 800 may include two or more retaining vessel layer components 802 and 804. In some aspects, each of the retaining vessel layer components 802 and 804 may be secured to the first vessel layer 700. In some aspects, the retaining vessel layer component 802 may be secured to the first vessel layer component 702, and the retaining vessel layer component 804 may be secured to the first vessel layer component 704. In some aspects, the retaining vessel layer components 802 and 804 may be secured to the first vessel layer components 702 and 704, respectively, before the first vessel layer components 702 and 704 are sealed to form the first vessel layer 700.

In some aspects, the first vessel layer 700 and the retaining vessel layer 800 may each have a material thickness of 4 mm or less. In some aspects, at least one of the first vessel layer 700 and the retaining vessel layer 800 may have a material thickness of 3 mm or less. In some aspects, the two or more first vessel layer components 702 and 704 and the two or more retaining vessel layer components 802 and 804 may be pressed components. In some aspects, the two or more first vessel layer components 702 and 704 and the two or more retaining vessel layer components 802 and 804 may be pressed components having a material thicknesses of 3 mm. In some aspects, the two or more first vessel layer components 702 and 704 may be pressed components having material thicknesses of 2 mm, and the two or more retaining vessel layer components 802 and 804 may be pressed components having material thicknesses of 4 mm (or vice versa). Although the first vessel layer 700 and the retaining vessel layer 800 may each have a material thickness of 4 mm or less, this is not required, and, in some alternative aspects, one or more of the first vessel layer 700 and the retaining vessel layer 800 may have a thickness greater than 4 mm (e.g., 6 mm, 8 mm, 10 mm, 12 mm, 20 mm, 100 mm, etc.).

Although the multi-layered vessel 600 illustrated in FIGS. 6-9B has two first vessel layer components 702 and 704 and two or more retaining vessel layer components 802 and 804, this is not required, and, in some alternative aspects, the multi-layered vessel 600 may have a different number (e.g., 3, 4, 6, 8, 12, 20, etc.) of first vessel layer components and/or a different number (e.g., 3, 4, 6, 8, 12, 20, etc.) of retaining vessel layer components.

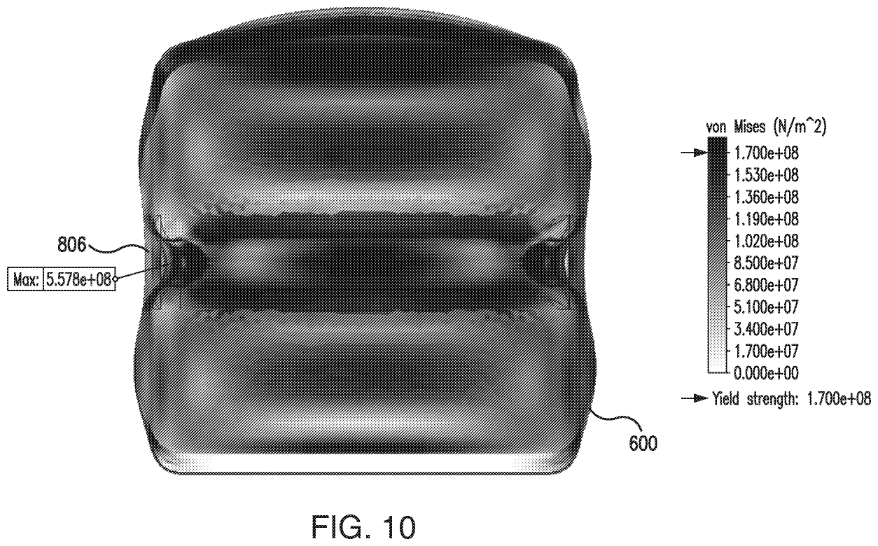

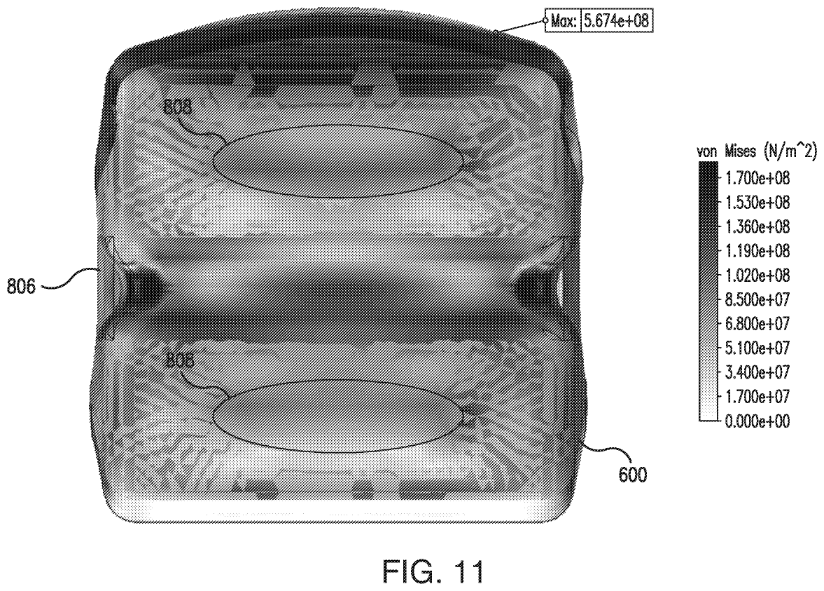

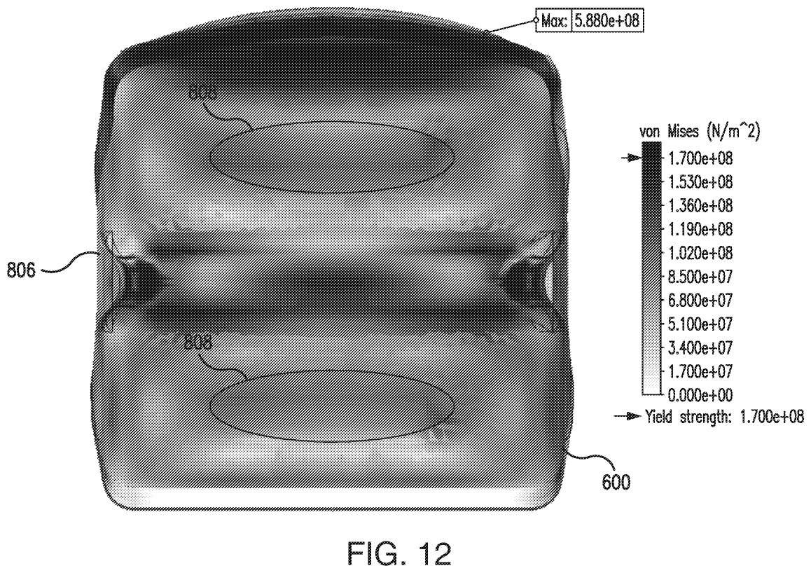

FIG. 10 illustrates the strength of an example of a multi-layered vessel 600 in which the first vessel layer 700 and the retaining vessel layer 800 have a material (e.g., steel) thickness of 3 mm. FIG. 11 illustrates the strength of an example of a multi-layered vessel 600 in which the first vessel layer 700 has a material (e.g., steel) thickness of 2 mm and the retaining vessel layer 800 has a material (e.g., steel) thickness of 4 mm and one or more openings 808, which reduce the weight of the retaining vessel layer 800 (and therefore the weight of the vessel 600). FIG. 12 illustrates the strength of an example of a multi-layered vessel 600 in which the first vessel layer 700 has a material (e.g., steel) thickness of 3 mm and the retaining vessel layer 800 has a material (e.g., steel) thickness of 3 mm and one or more openings 808, which reduce the weight of the retaining vessel layer 800 (and therefore the weight of the vessel 600).

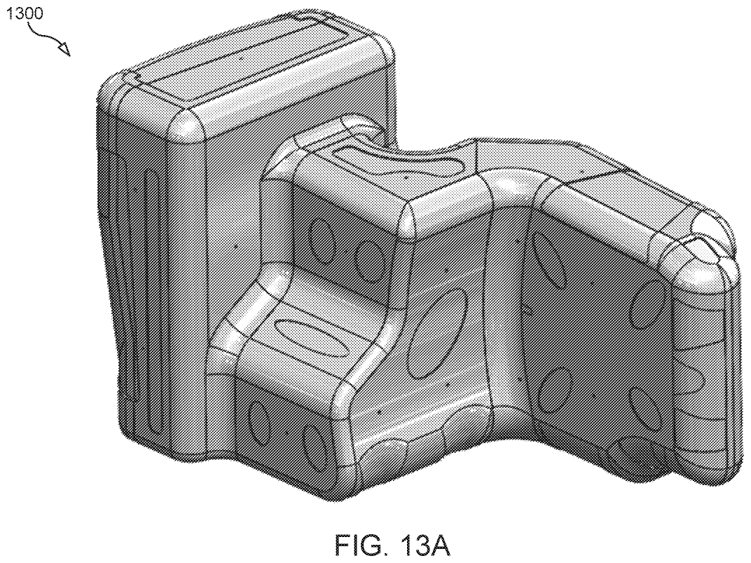

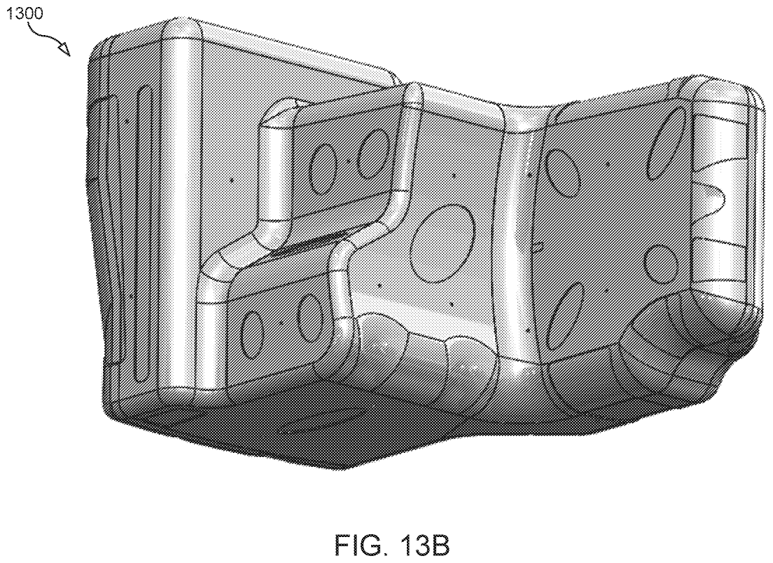

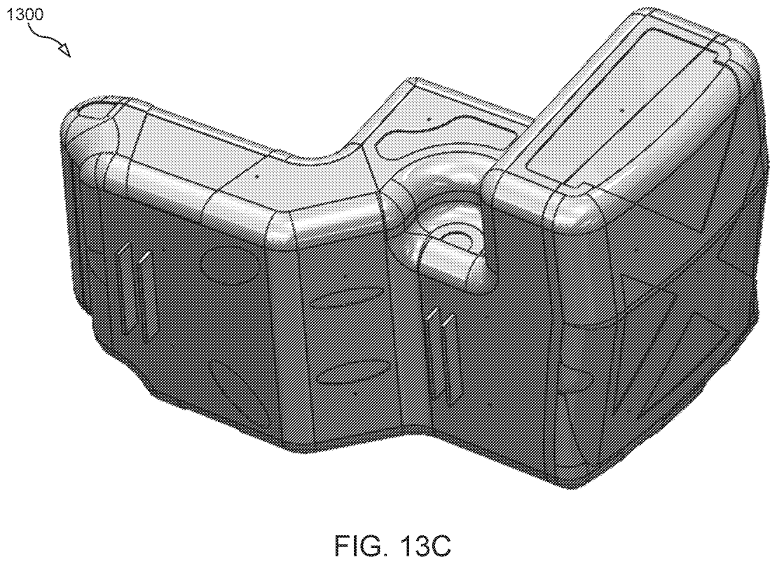

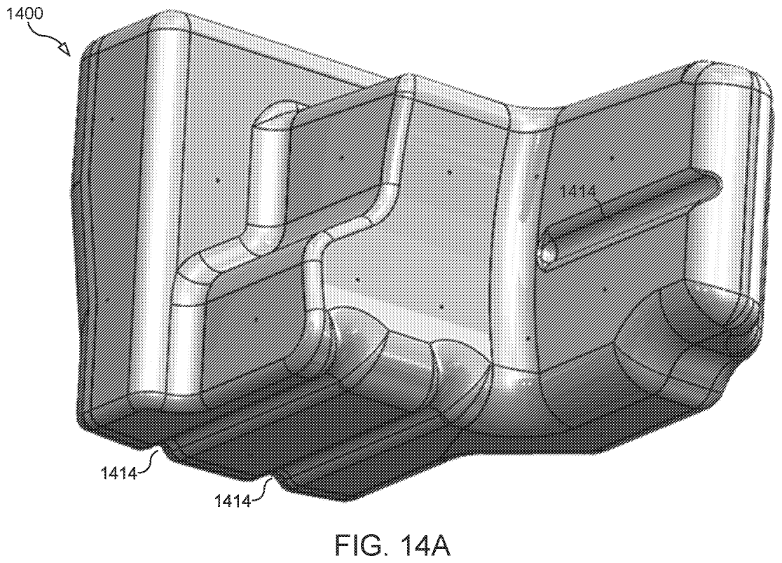

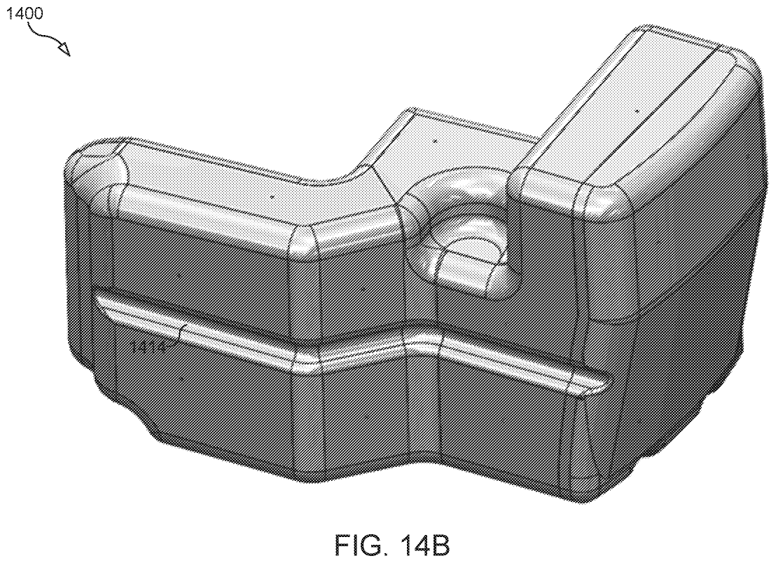

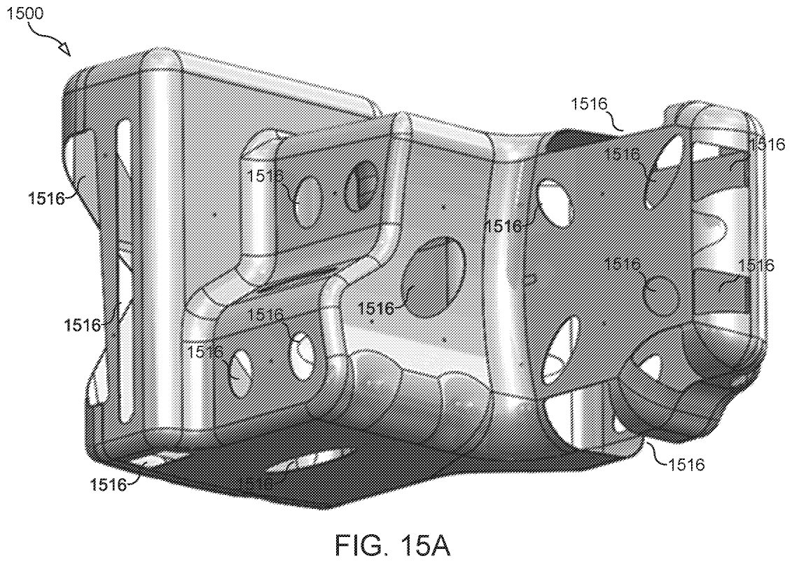

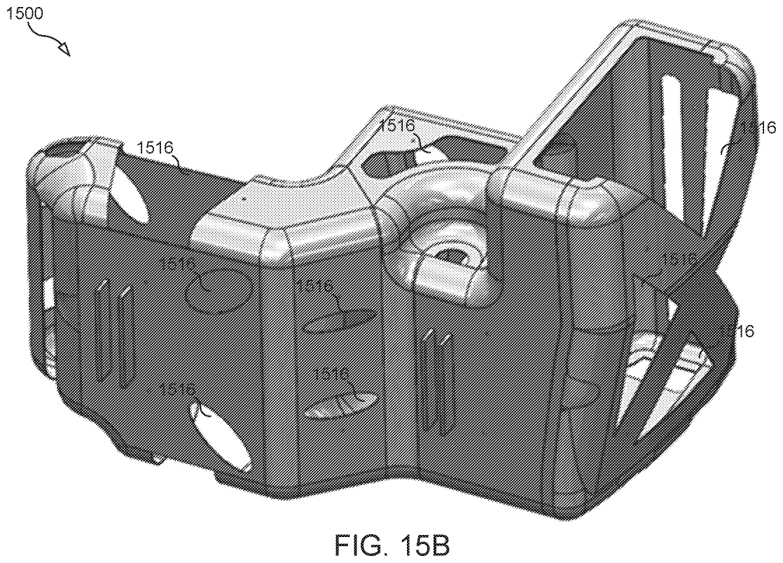

FIGS. 13A-17 illustrate a multi-layered vessel 1300 (e.g., a multi-layered pressure vessel) according to some aspects. In some aspects, the multi-layered vessel 1300 includes a first vessel layer 1400 and a retaining vessel layer 1500. FIGS. 14A and 14B illustrate the first vessel layer 1400 of the multi-layered vessel 1300 according to some aspects. FIGS. 15A and 15B illustrate the retaining vessel layer 1500 of the multi-layered vessel 1300 according to some aspects. In some aspects, the first vessel layer 1400 and the retaining vessel layer 1500 may be made out of a material (e.g., steel).

In some aspects, the retaining vessel layer 1500 may be configured to strengthen the first vessel layer 1400. In some aspects, the retaining vessel layer 1500 may be secured to outer walls of the first vessel layer 1400. In some aspects, the retaining vessel layer 1500 may be secured to the first vessel layer 1400 by welding, crimping, and/or forming. In some aspects, the retaining vessel layer 1500 may be secured to the first vessel layer 1400 by spot welding and/or plug welding. In some alternative aspects, the retaining vessel layer 1500 may be secured to the first vessel layer 1400 by cold bonding (e.g., using a glue or adhesive). In some aspects, the retaining vessel layer 1500 may be secured to the first vessel layer 1400 by cold welding (e.g., including wire brushing and pressing the layers 1400 and 1500 together)

In some aspects, the first vessel layer 1400 and the retaining vessel layer 1500 may be made of the same material or different materials. For example, in some aspects, the first vessel layer 1400 may be made of steel (e.g., stainless steel) or aluminum, and the retaining vessel layer 1500 may be made of steel, aluminum, composite, or plastic.

In some aspects, as shown in FIGS. 14A and 14B, the first vessel layer 1400 may form a sealed vessel. In some alternative aspects, the first vessel layer 1400 and the retaining vessel layer 1500 may overlap and form a sealed vessel. In some further alternative aspects, the multi-layered vessel 1300 may further include one or more additional retaining vessel layers, and the first vessel layer 1400, the retaining vessel layer 1500, and the one or more additional retaining vessel layers may overlap and form a sealed vessel.

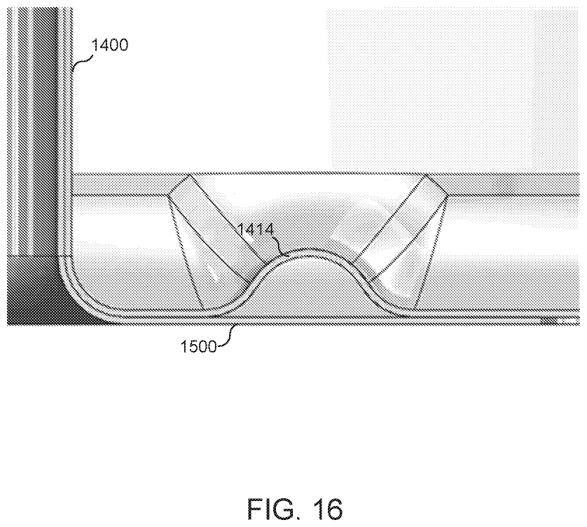

In some aspects, as shown in FIGS. 14A-17, the first vessel layer 1400 may include one or more strengthening structures 1414. In some aspects, the retaining vessel layer 1500 may additionally or alternatively include one or more strengthening structures 1414. In some aspects, the one or more strengthening structures 1414 may include one or more strengthening beams. In some aspects, as shown in FIG. 16, at least one of the one or more strengthening beams 1414 may include a trench in the first vessel layer 1400 that is closed by the retaining vessel layer 1500. In some aspects, the trench in the first vessel layer 1400 that is closed by the retaining vessel layer 1500 may have fluid in it. In some aspects, as shown in FIGS. 14A and 14B, the trench of the one or more strengthening structures 1414 may have a curved (e.g., U-shaped) cross-section. However, this is not required, and, in some alternative aspects, the trench may have a different shape (e.g., a V-shaped cross-section). In some aspects, the first vessel layer 1400 and/or retaining vessel layer 1500 may additionally or alternatively include one or more strengthening structures 1414 having more complex geometries than trenches and beams. In some aspects, the one or more strengthening structures 1414 having more complex geometries may, for example, have feature shapes that provide further strength across different surface directions and planes (e.g., curved or spherical depressions and/or raised areas, cross type recesses, and/or raised features). In some aspects, the one or more strengthening structures 1414 may include one or more supports in a trench of the first vessel layer 1400. In some aspects, the one or more supports may be configured to abut the retaining vessel layer 1500. In some aspects, the one or more supports may be welded to the retaining vessel layer 1500.

In some aspects, as shown in FIGS. 15A and 15D, the retaining vessel layer 1500 may include one or more openings 1516. In some aspects, the one or more openings 1506 in the retaining vessel layer 1500 may be located at the areas of the first vessel layer 1400 that are strong and, thus, do not need to be strengthened by the retaining vessel layer 1500. In some aspects, the one or more openings 1516 may reduce the amount of material required for the retaining vessel layer 1500. In some aspects, the one or more openings 1516 in the retaining vessel layer 1500 may reduce the weight of the retaining vessel layer 1500 and, therefore, reduce the weight of the multi-layered vessel 1300. However, the one or more openings 1516 in the retaining vessel layer 1500 are not required and, in some alternative aspects, the retaining vessel layer 1500 may not include one or more openings.

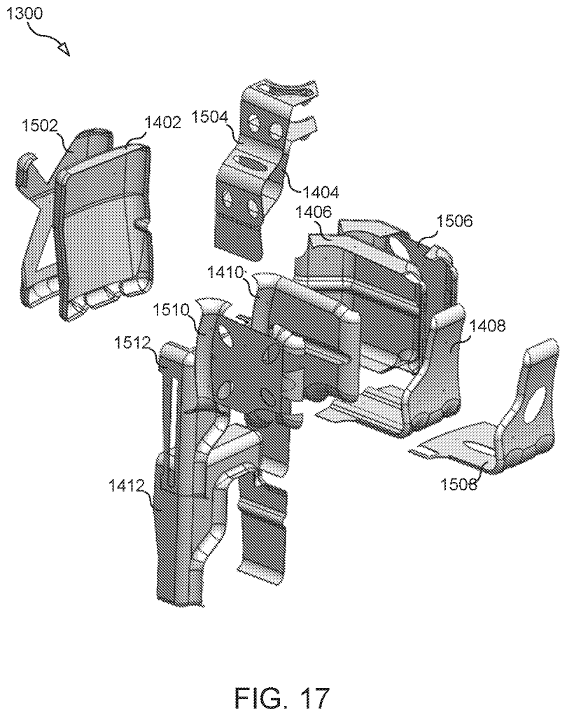

In some aspects, as shown in FIG. 17, the first vessel layer 1400 may include two or more first vessel layer components (e.g., first vessel layer components 1402, 1404, 1406, 1408, 1410, and 1412) that are welded together to form the first vessel layer 1400. In some aspects, as shown in FIG. 17, the retaining vessel layer 1500 may include two or more retaining vessel layer components (e.g., retaining vessel layer components 1502, 1504, 1506, 1508, 1510, and 1512). In some aspects, each of the retaining vessel layer components 1502, 1504, 1506, 1508, 1510, and 1512 may be secured to the first vessel layer 1400. In some aspects, the retaining vessel layer components 1502, 1504, 1506, 1508, 1510, and 1512 may be secured to the first vessel layer components 1402, 1404, 1406, 1408, 1410, and 1412, respectively. In some aspects, the retaining vessel layer components 1502, 1504, 1506, 1508, 1510, and 1512 may be secured to the first vessel layer components 1402, 1404, 1406, 1408, 1410, and 1412, respectively, after the first vessel layer components 1402, 1404, 1406, 1408, 1410, and 1412 are sealed to form the first vessel layer 1400. In some alternative aspects, the retaining vessel layer components 1502, 1504, 1506, 1508, 1510, and 1512 may be secured to the first vessel layer components 1402, 1404, 1406, 1408, 1410, and 1412, respectively, before the first vessel layer components 1402, 1404, 1406, 1408, 1410, and 1412 are sealed to form the first vessel layer 1400.

In some aspects, the first vessel layer 1400 and the retaining vessel layer 1500 may each have a material thickness of 4 mm or less. In some aspects, at least one of the first vessel layer 1400 and the retaining vessel layer 1500 may have a material thickness of 3 mm or less. In some aspects, the two or more first vessel layer components 1402, 1404, 1406, 1408, 1410, and 1412 and the two or more retaining vessel layer components 1502, 1504, 1506, 1508, 1510, and 1512 may be pressed components. In some aspects, the two or more first vessel layer components 1402, 1404, 1406, 1408, 1410, and 1412 and the two or more retaining vessel layer components 1502, 1504, 1506, 1508, 1510, and 1512 may be pressed components having a material thicknesses of 3 mm. In some aspects, the two or more first vessel layer components 1402, 1404, 1406, 1408, 1410, and 1412 may be pressed components having material thicknesses of 2 mm, and the two or more retaining vessel layer components 1502, 1504, 1506, 1508, 1510, and 1512 may be pressed components having material thicknesses of 4 mm (or vice versa). Although the first vessel layer 1400 and the retaining vessel layer 1500 may each have a material thickness of 4 mm or less, this is not required, and, in some alternative aspects, one or more of the first vessel layer 1400 and the retaining vessel layer 1500 may have a thickness greater than 4 mm (e.g., 6 mm, 8 mm, 10 mm, 12 mm, 20 mm, 100 mm, etc.).

Although the multi-layered vessel 1300 illustrated in FIGS. 13A-17 has six first vessel layer components 1402, 1404, 1406, 1408, 1410, and 1412 and two or more retaining vessel layer components 1502, 1504, 1506, 1508, 1510, and 1512, this is not required, and, in some alternative aspects, the multi-layered vessel 1300 may have a different number (e.g., 2, 3, 4, 8, 12, 20, etc.) of first vessel layer components and/or a different number (e.g., 2, 3, 4, 8, 12, 20, etc.) of retaining vessel layer components.

In some aspects, a storage tank may include the multi-layered vessel 600 or 1300. In some aspects, the multi-layered vessel 600 or 1300 may be a first multi-layered vessel. In some aspects, the storage tank may further include a second vessel, and the first vessel may be arranged within the second vessel or the second vessel may be arranged within the first vessel. In some aspects, the second vessel may have a second sealed vessel and a second retaining vessel configured to strengthen the second sealed vessel, and the second retaining vessel may be secured to outer walls and/or inner walls of the second sealed vessel. In some aspects, the storage tank may further include a vacuum gap between the first and second vessels.

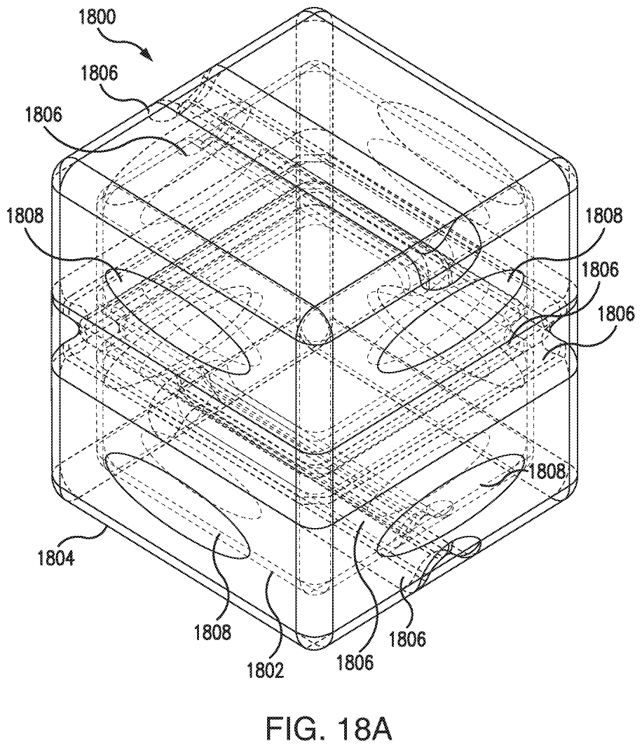

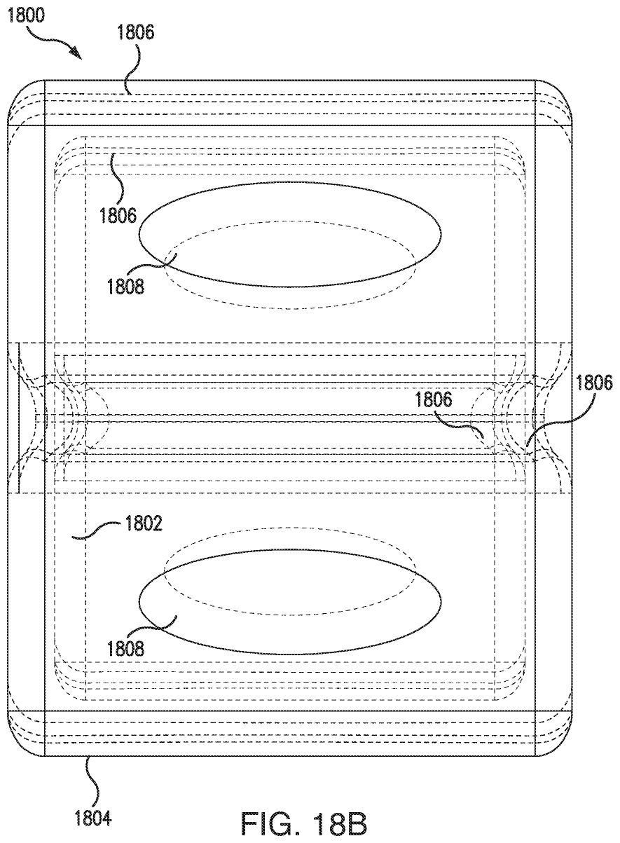

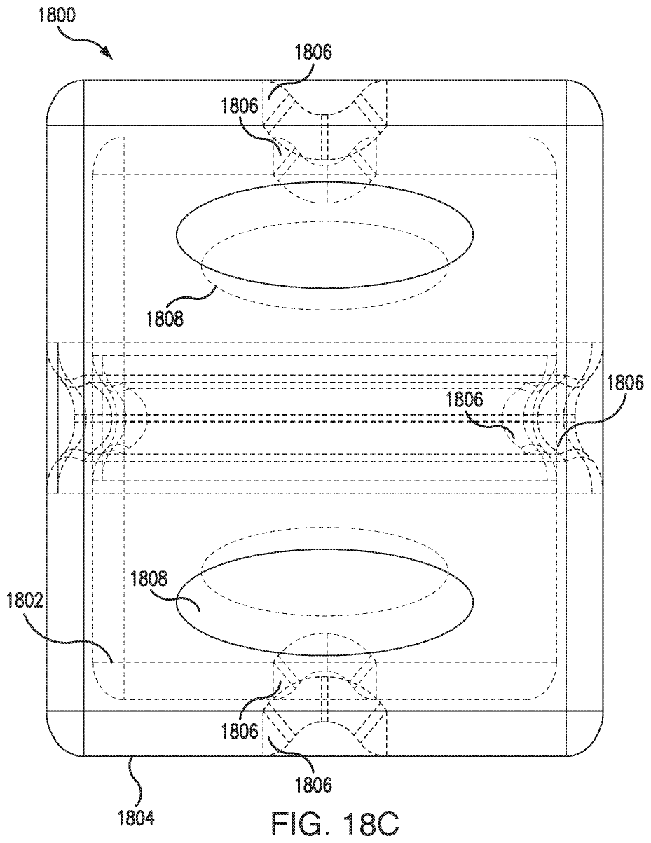

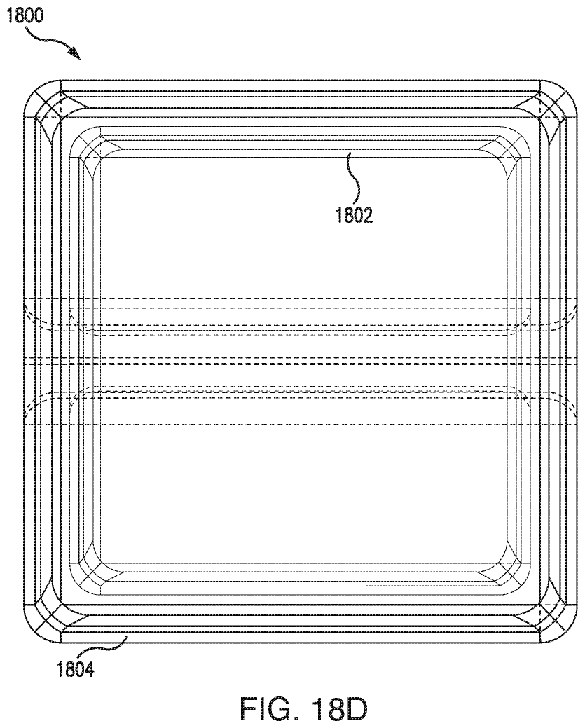

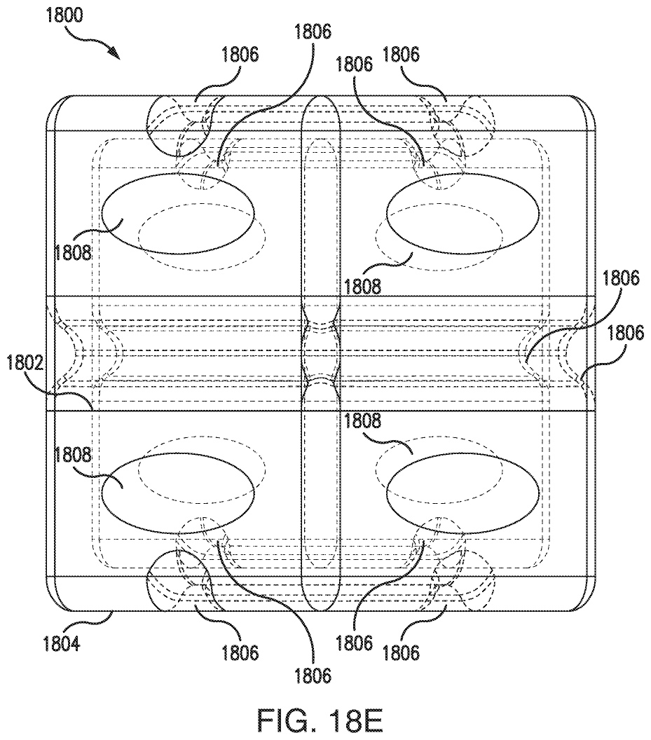

For example, in some aspects, as shown in FIGS. 18A-18E, a storage tank 1800 (e.g., for use with cryogenics) may include an inner vessel 1802 and an outer multi-layered vessel 1804. In some aspects, one or both of the inner and outer vessels 1802 and 1804 may be multi-layered vessels. In some aspects, one or both of the inner and outer vessels 1802 and 1804 may include one or more of the features described above with respect to the multi-layered vessel 600. For example, in some aspects, one or both of the inner and outer vessels 1802 and 1804 may include a first vessel layer and a retaining vessel layer configured to strengthen the first vessel layer, and the retaining vessel layer may be secured to outer walls and/or inner walls of the first vessel layer. For another example, in some aspects, one or both of the inner and outer vessels 1802 and 1804 may include one or more strengthening structures 1806. For yet another example, in some aspects, a retaining vessel layer of one or both of the inner and outer vessels 1802 and 1804 may include one or more openings 1808. In some aspects, the retaining vessel layer of the outer vessel 1804 may be configured to hold the inner vessel 1802 in place inside the outer vessel 1804 (e.g., such that a separate mounting system for mounting the inner vessel 1802 inside the outer vessel 1804 may be required). However, this is not required, and, in some alternative aspects, a mounting system in addition to the retaining vessel layer of the outer vessel 1804 may be used to hold the inner vessel 1802 in place inside the outer vessel 1804.

In some aspects, a vehicle may include the storage tank and an engine. In some aspects, the storage tank 1800 may be mounted in the vehicle and connected to the engine of the vehicle, and the storage tank may be configured to deliver methane to the engine. In some alternative aspects, the storage tank 1800 may be mounted in or on plant machinery and connected to a processor, and the storage tank may be configured as a buffer for fluid storage.

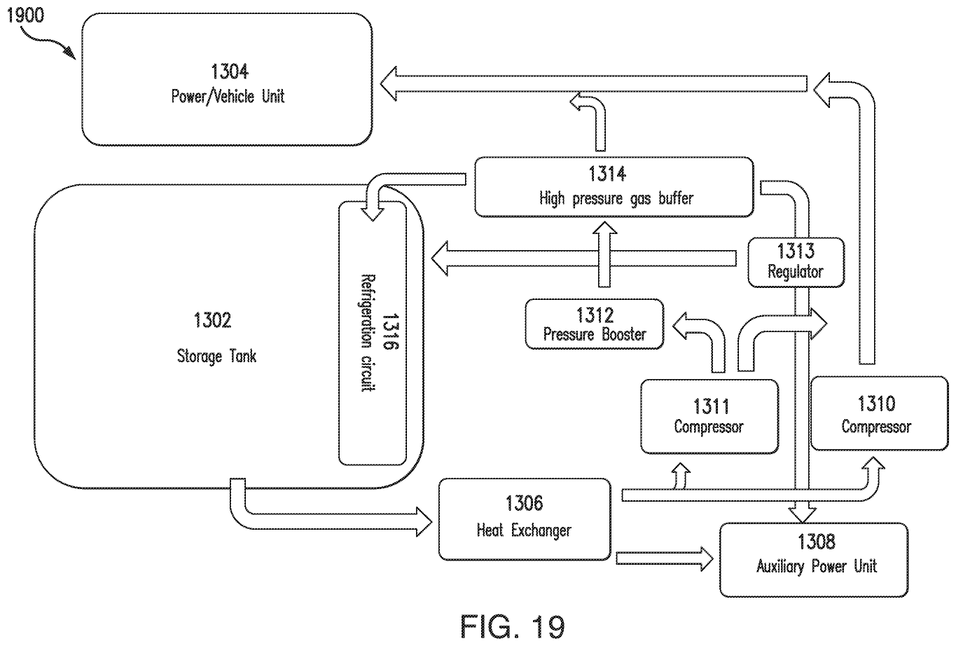

FIG. 19 illustrates a system 1900 for the storage and delivery of a fuel (e.g., methane) according to some aspects. In some aspects, the system 1900 may include a storage tank 1302 (e.g., a multi-layered pressure vessel). In some aspects, the storage tank 1302 may be a low pressure fuel storage tank. In some aspects, the storage tank 1302 may be, for example, the multi-layered vessel 600 illustrated in FIGS. 6-9B or the multi-layered vessel 1300 illustrated in FIGS. 13A-17. In some aspects, the storage tank 1302 may include a first multi-layered vessel (e.g., multi-layered vessel 600 or 1300) and a second vessel (e.g., a second vessel arranged within the first multi-layered vessel).

In some aspects, the system 1900 may include a heat exchanger 1306, an auxiliary power unit 1308, a liquefaction/refrigeration circuit 1316, a gas compressor 1310, and/or a high pressure buffer 1314 and booster 1312. In some aspects, the buffer 1314 may be, for example, the multi-layered vessel 600 illustrated in FIGS. 6-9B or the multi-layered vessel 1300 illustrated in FIGS. 13A-17. In some aspects, the buffer 1314 may include a first multi-layered vessel (e.g., multi-layered vessel 600 or 1300) and a second vessel (e.g., a second vessel arranged within the first multi-layered vessel). In some aspects, the system 1900 may be configured so that the liquid methane is held at the lowest possible temperature, thereby increasing the energy density to its maximum.

In some aspects, upon receiving a demand for gaseous methane, the compressor 1310 may be powered up, forcing gas into the engine 1304. In some aspects, the engine 1304 may be a combustion or non-combustion engine. In some aspects, a flameless heat engine may be used, in which a catalyst is used to heat the gas before passing it to a gas turbine. In some aspects, gas may be forced back into the multi-layered vessel 1302 via a regulator, pressurizing the multi-layered vessel 1302 to force more liquid methane out through the heat exchanger 1306, where it is vaporized before being compressed and forced into the engine to continue the cycle. That is, gas may be passed to the multi-layered vessel 1302 from compressor 1310 (or a compressor 1311) via regulator 1313. In this way, the components of system 1900 may be used in conjunction to simultaneously deliver the necessary fuel to unit 1304, such as an engine, while ensuring that additional fuel will be vented from multi-layered vessel 1302 for sustained delivery and use.

In some aspects, a second compressor 1311 may be used. The second compressor 1311 may be coupled to the multi-layered vessel 1302. In some aspects, the second compressor 1311 may be in parallel with the first compressor 1310. In some aspects, the second compressor 1311 may be used, for example, to deliver methane gas under high demand. In some aspects, the second compressor 1311 may be arranged to act independently of the first compressor 1310 to supply methane gas to a pressure booster, such as booster 1312. This may be, for instance, to achieve high pressure for storage in the high pressure buffer 1314 or to drive a cooling unit, such as refrigeration circuit 1316. In some aspects, as shown in FIG. 19, regulator 1313 may be further connected to compressor 1311 and used to direct gas to one or more of buffer 1314 and multi-layered vessel 1302. Although depicted as a single component, in some instance, regulator 1313 may include a plurality of regulation components, including one or more valves. In some aspects, the first and second compressors 1310, 1311 may be located anywhere on the vehicle serviced by the necessary pipework, control, and power cables. In some aspects, one or more of the compressors 1310, 1311 may take gas at low pressure, for example, 3 bar, and delivers it to an engine at higher pressure, such as 10 bar. This could be, in some aspects, with a combined output rate of 16 grams per second.

By way of example, during normal vehicle cruising operation one compressor, such as compressor 1310, could be sufficient to deliver methane at a first level, such as at 8 grams per second to the engine. In this instance, the second compressor, such as compressor 1311, could be reserved for additional tasks, as required. As an example, the second compressor 1311 could be used to supply gas to a regulator, or a pressure booster and fill a high pressure buffer. In some aspects, when there is a need to cool a fuel stored in a tank, such as liquid methane in multi-layered vessel 1302, high pressure methane from the buffer or from the output of a pressure booster can be passed through a refrigeration element, such as a Joule Thompson refrigeration circuit inside the multi-layered vessel 1302, re-condensing the methane to a liquid that is colder than the main reservoir. This could increase the hold time left before the methane would need to be vented, or make additional space available for fresh fuel because the colder methane is denser.

In some aspects, initial start-up of a vehicle, including for instance starting power/vehicle unit 1304, can be achieved using fuel stored in a high pressure buffer, such as buffer 1314, which can store methane gas. This could allow, for example, the first compressor 1310 to start independently of the pressure in the multi-layered vessel 1302, which may be low according to some aspects. In certain aspects, once the compressor 1310 is running, a regulator 1313 can be used to bleed some gas into the multi-layered vessel 1302. In some aspects, gas is bled to the multi-layered vessel 1302 at 3 bar. In some respects, the multi-layered vessel 1302 pressure is therefore set independently of the liquid methane vapor pressure. In some aspects, for instance in situations that require high gas flow, a pressure raising circuit can be incorporated. This can enable the pressure of the multi-layered vessel 1302 to be increased by boiling off some of the liquid, for example through a heat exchanger attached to the inside wall of an outer vacuum vessel. In this way, pressure in the multi-layered vessel 1302 can be maintained during periods of high usage.

In some aspects, auxiliary power unit 1308 may serve a number of roles. In some aspects, auxiliary power unit 1308 may be positioned anywhere on a vehicle and connected via the necessary pipes. Auxiliary power unit 1308 may be used to extract energy from the methane gas that would otherwise have to be vented when the pressure in the multi-layered vessel 1302 is rising but the vehicle or generator is not being used. Electrical energy may be generated by unit 1308, for instance, with a fuel cell arrangement and/or a secondary engine by using some of the methane. The electrical energy can be stored in a battery.

In some aspects, auxiliary power unit 1308 can be also be used to provide power and/or heat to a vehicle's quarters, including for instance a cabin or “hotel” load when the driver is sleeping overnight. For very cold starts, for example, it can be run exclusively from the high pressure buffer to generate heat for the heat exchanger, e.g. heat exchanger 1306, that vaporizes the liquid methane before the vehicles main engine is sufficiently warm.

In some aspects, system 1900 may operate in a state in which a multi-layered vessel 1302 is at an increased pressure. For example, they system 1900 may operate when the multi-layered vessel 1302 has been left for a period of time allowing heat to boil the stored fuel, such as liquid methane, thereby increasing the pressure. In some aspects, a valve is opened for feeding the excess methane gas to an auxiliary power unit (such as a combustion engine or fuel cell) where power is generated and stored in a battery. This could be unit 1308, for instance. Power from the battery can then be used to power a compressor to take excess gas from the multi-layered vessel 1302 and pass it through a pressure booster (e.g., booster 1312) and cooling unit (e.g., refrigeration circuit 1316) to re-liquefy excess gas and return it to the main reservoir. This can advantageously reduce the main reservoir's temperature and extend its non-venting storage time. In some alternative aspects, a compressor and booster can be used to take low pressure gas from the multi-layered vessel 1302 and store it in a highly compressed gaseous state in a high pressure buffer, such as buffer 1314, that acts as an independent reservoir that can be used to initiate the starting sequence of the main engine or supply the auxiliary power unit as required.

Although one larger low pressure compressor could be used, in some aspects, to supply sufficient gas to the engine when under maximum demand the use of two lower flow compressors acting independently may be used. In some cases, under normal operation, one compressor can fulfil the sufficient fuel delivery, saving energy. Further, to provide a high pressure buffer volume, the second compressor can be used independently. By pumping gas through a pressure booster, a high pressure reservoir can be filled. This can then be used to either power the engine during a cold start or keep the liquid reservoir cold by passing through a Joule Thompson refrigeration system positioned within the inner liquid methane tank. This system can be used to keep the main reservoir cold, thereby sustaining low pressure operation.

Although methane is used as an example, the storage elements described herein can be used for storage, including cryogenic storage, of other materials as well. For instance, hydrogen fuels may be used, and other materials (e.g., oxygen, helium, argon, and nitrogen) may be stored according to the aspects described herein. Similarly, fuel storage and delivery systems according to aspects also apply to non-methane fuels.

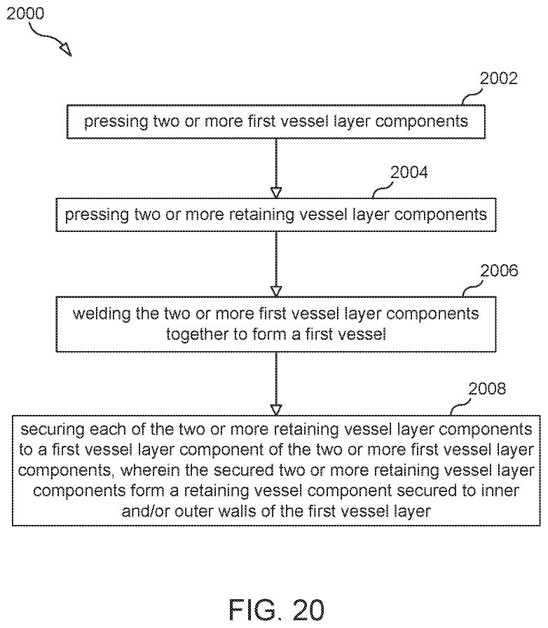

FIG. 20 illustrates a process 2000 for manufacturing a multi-layered vessel 600 or 1300 according to some aspects. In some aspects, the process 2000 may include a step 2002 of pressing two or more first vessel layer components (e.g., first vessel layer components 702 and 704 or first vessel layer components 1402, 1404, 1406, 1408, 1410, and 1412). In some aspects, the process 2000 may include a step 2004 of pressing two or more retaining vessel layer components (e.g., retaining vessel layer components 802 and 804 or retaining vessel layer components 1502, 1504, 1506, 1508, 1510, and 1512). In some aspects, the process 2006 may include a step 2006 of welding the two or more first vessel layer components together to form a first vessel layer 700 or 1400. In some aspects, the process 2000 may include a step 2008 of securing each of the two or more retaining vessel layer components to a first vessel layer component of the two or more first vessel layer components, and the secured two or more retaining vessel layer components may form a retaining vessel layer 800 or 1500 secured to inner and/or outer walls of the first vessel layer 700 or 1400.

While various aspects are described herein, it should be understood that they have been presented by way of example only, and not limitation. Thus, the breadth and scope of this disclosure should not be limited by any of the above-described exemplary aspects. Moreover, any combination of the above-described elements in all possible variations thereof is encompassed by the disclosure unless otherwise indicated herein or otherwise clearly contradicted by context. For example, in some aspects, a similar multilayer approach could be used to form a vacuum vessel where the opposing force is pushing in rather than pushing out.

Additionally, while the processes described above as a sequence of steps, this was done solely for the sake of description. Accordingly, it is contemplated that some steps may be added, some steps may be omitted, the order of the steps may be re-arranged, and some steps may be performed in parallel.

1. A multi-layered vessel comprising:
a first vessel layer; and
a retaining vessel layer configured to strengthen the first vessel layer, wherein the retaining vessel layer is secured to outer walls and/or inner walls of the first vessel layer.

2. The multi-layered vessel of claim 1, wherein (a) the first vessel layer forms a sealed vessel, (b) the first vessel layer and the retaining vessel layer overlap and form a sealed vessel, or (c) the multi-layered vessel further comprises one or more additional retaining vessel layers, and the first vessel layer, the retaining vessel layer, and the one or more additional retaining vessel layers overlap and form a sealed vessel.

3. (canceled)

4. (canceled)

5. The multi-layered vessel of claim 1, wherein the first vessel layer and/or the retaining vessel layer comprise one or more strengthening structures.

6. The multi-layered vessel of claim 5, wherein the one or more strengthening structures comprise one or more strengthening beams.

7. The multi-layered vessel of claim 6, wherein at least one of the one or more strengthening beams comprises a trench in one of the first vessel layer and the retaining vessel layer that is closed by the other of the first vessel layer and the retaining vessel layer.

8. The multi-layered vessel of claim 5, wherein the one or more strengthening structures comprise curved or spherical depressions and/or raised areas, cross type recesses, and/or raised features.

9. The multi-layered vessel of claim 1, wherein the retaining vessel layer comprises one or more openings.

10. The multi-layered vessel of claim 1, wherein the first vessel layer and the retaining vessel layer each have a material thickness of 4 mm or less, and/or at least one of the first vessel layer and the retaining vessel layer has a material thickness of 3 mm or less.

11. (canceled)

12. The multi-layered vessel of claim 1, wherein the retaining vessel layer is secured to the first vessel layer by welding, crimping, and/or forming.

13. (canceled)

14. The multi-layered vessel of claim 1, wherein the first vessel layer comprises two or more first vessel layer components that are welded together to form the first vessel layer.

15. The multi-layered vessel of claim 1, wherein the retaining vessel layer comprises two or more retaining vessel layer components, and each retaining vessel layer component is secured to a first vessel layer component of the two or more first vessel layer components.

16. The multi-layered vessel of claim 15, wherein the two or more first vessel layer components and the two or more retaining vessel layer components are pressed components, and (a) the two or more first vessel layer components and the two or more retaining vessel layer components are pressed components having a material thicknesses of 3 mm or (b) the two or more first vessel layer components are pressed components having material thicknesses of 2 mm, and the two or more retaining vessel layer components are pressed components having material thicknesses of 4 mm.

17. (canceled)

18. (canceled)

19. The multi-layered vessel of claim 16, wherein each of the two or more retaining vessel layer components is secured to a first vessel layer component of the two or more first vessel layer components after the two or more first vessel layer components are sealed to form the first vessel layer.

20. The multi-layered vessel of claim 16, wherein one or more of the two or more retaining vessel layer components is secured to a first vessel layer component of the two or more first vessel layer components before the two or more first vessel layer components are sealed to form the first vessel layer.

21. The multi-layered vessel of claim 1, wherein the retaining vessel layer comprises two or more retaining vessel layer components, and each of the retaining vessel layer components is secured to the first vessel layer.

22. A storage tank comprising:
the multi-layered vessel of claim 1, wherein the multi-layered vessel is a first multi-layered vessel; and
a second vessel, wherein the first multi-layered vessel is arranged within the second vessel or the second vessel is arranged within the first vessel.

23. The storage tank of claim 22, wherein (a) the storage tank is mounted in a vehicle and connected to an engine of the vehicle, and the storage tank is configured to deliver methane to the engine, or (b) the storage tank is mounted in or on plant machinery and connected to a processor, and the storage tank is configured as a buffer for fluid storage.

24. (canceled)

25. The storage tank of claim 22, wherein the second vessel is a second multi-layered vessel comprising:
a first vessel layer; and
a retaining vessel layer configured to strengthen the first vessel layer of the second multi-layered vessel, wherein the retaining vessel layer of the second multi-layered vessel is secured to outer walls and/or inner walls of the first vessel layer of the second multi-layered vessel.

26. The storage tank of claim 22, further comprising a vacuum gap between the first and second vessels.

27. A method comprising:
pressing two or more first vessel layer components;
pressing two or more retaining vessel layer components;
welding the two or more first vessel layer components together to form a first vessel; and
securing each of the two or more retaining vessel layer components to a first vessel layer component of the two or more first vessel layer components, wherein the secured two or more retaining vessel layer components form a retaining vessel component secured to inner and/or outer walls of the first vessel layer.

28-30. (canceled)
